(19) United States
(12) Patent Application Publication
(10) Pub. No.: US 2010/0194755 A1
(43) Pub. Date: Aug. 5, 2010

(54) Identifying a Point on a Signal

(75) Inventors: Vincent Foo, Bayan Lepas (MY); Siew Kin Ong, Kamunting (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/363,717

(22) Filed: Jan. 30, 2009

(51) Int. Cl. G06T 11/20

(52) U.S. Cl. 345/440

(57) ABSTRACT

A method and apparatus for identifying a point on a rendered signal. The rendered signal comprises display-points that correspond to sampled points. A portion of the sampled-points is displayed. A sampled-point is selected from the portion displayed. The signal is rendered on the display to include the display point corresponding to the sampled-point.

### BACKGROUND OF THE INVENTION

Signal measuring systems sample an incoming signal for subsequent analysis by a user. Examples of signal measuring systems are oscilloscopes and spectrum analyzers. Sampled-points are then displayed as display-points to form a graphical representation of the signal (also referred to as a “rendered signal”).

The rendered signal is typically depicted on a display of the measuring system. Further analysis can then be performed on the rendered signal. Alternatively, the sampled-points can be sent to a computer for viewing and further analysis.

A typical representation of the sampled-points on the oscilloscope is a time-amplitude graph (time-voltage signal) or a frequency-amplitude graph (spectral signal) on the spectrum analyzer. The graphs can be a discrete representation of acquired samples or a continuous waveform.

FIG. 1 is a block diagram of an oscilloscope 100 found in the art. The oscilloscope 100 comprises a processor unit 102 coupled to a display 104, a control knob 106, a memory unit (MU) 108, and an Analog to Digital Converter (ADC) 120.

The control knob 106 is an example of an input interface. The input interface allows the user to provide an input. The input interface can be a soft key on the display 104. Other examples of the user input interface are a keyboard, a mouse, or a keypad. Alternatively, the input interface can be the entire display 104 if the display is a touch screen display, enabling the user to make an input by pointing with a finger or a pen.

A computer readable media drive 126 allows the processor unit 102 to access data stored thereon.

The ADC 120 converts signals from two signal inputs 122 and a trigger 124. Signals to be measured are provided at the signal inputs 122. Each signal is sampled by the ADC 120 to create sampled-points. The sampled-points are stored in the MU 108. The sampled-points include data on the magnitude of the signal at an instance following a trigger.

The signal is rendered on the display 104 by the processor unit 102 using the sampled-points from the MU 108. If the display 104 is not able to accommodate a long span of sampled-points, the rendered signal can comprise display-points that correspond to a part of the sampled-points.

Typically, the correspondence between the display-points and the sampled-points is one-to-one relationship. It is also likely that more than one sampled-point may make up one display-point.

The correspondence can include interpolated display-points. By way of an example, a first signal with a smaller number of sampled-points is rendered on a display to be compared with a second signal with a larger number of sampled-points. The sampled-points and the interpolated sampled-points of the first signal correspond to display-points that represent a new rendered signal.

Analyzing the signal commences when a user selects a display-point. This is done by moving a marker on the display-point using the control knob 106.

Typically, the rendered signal is dense with display-points. The display-points can be difficult to visually differentiate from each other, making the positioning of the marker on a desired display-point a challenge. This problem is compounded in hand-held devices where the display is limited in size or has limited pixel resolution.

The placement of one or more markers on the display-points of the rendered signal can be applied in various analysis, for example, noise plateaus, the location of local peaks, abnormalities and inflections of the rendered signal, as well as identifying thresholds to compare the rendered signal to. The user can find the accurate placement of markers to be time consuming as the identification of a desired display-point involves many steps.

These steps include traversing a marker across the rendered signal. The user simultaneously monitors a readout of a sampled-point corresponding to the display-point at which the marker is positioned on. These steps are performed one display-point at a time. The user may make a mental or physical note of many sampled-points before a desired analysis in the rendered signal is identified.

In some prior-art technologies, the step of zooming into a rendered signal can depict the display-points in a less dense setting (fewer display-points rendered in a display). This can allow for the selection of a particular display-point and the subsequent placement of a marker thereon.

Examples of such prior-art include U.S. Pat. No. 6,642,936 B1 issued to Engholm et al., entitled “TOUCH ZOOM IN/OUT FOR A GRAPHICS DISPLAY”, issued on Nov. 4, 2003, and U.S. Pat. No. 7,227,549 issued to Beasley et al., entitled “INDICATING AND MANUPULATING A ZOOM REGION OF A WAVEFORM” issued on Jun. 5, 2007.

However, zooming into an appropriate magnification setting within an area of the display 104 can require many steps. The magnified view can disadvantage the user by rendering some of the display-points outside the viewable area of the display, thereby requiring the user to zoom out and repeat the steps of zooming into another area in order to select particular display-points.

In another prior-art technology, a scroll bar is manipulated to locate a position on the rendered signal or to vary the segment of the rendered signal on the display. This is useful in the analysis of a long time-span of sampled-points, for example, measuring systems designed for the medical field.

An example of such prior art includes U.S. Pat. No. 5,739,817 to Glei et al. entitled “METHOD AND APPARATUS FOR DISPLAYING POSITION INFORMATION ADJACENT TO A SCROLL BOX” and issued on Apr. 14, 1998.

However, varying the segment of the rendered signal on the display can be time consuming as the user would have to scroll through the entire rendered-signal before selecting a desired display-point.

Furthermore, the approaches described in the paragraphs above still limit the marker position control or display-point selection. This is because the marker control and display-point selection continue to depend on the resolution of the display and the visual dexterity of the user.

Thus a need exists to quickly, reliably, and accurately identify a display-point on a signal during an analysis of the rendered signal.

### BRIEF DESCRIPTION OF THE DRAWINGS

FIG. 1 is a block diagram of an oscilloscope in the art;

FIG. 2 is an illustration of a display showing rendered signals and a table of sampled-points on a display in an embodiment of the invention;

FIG. 3 is an illustration of the display and the rendered signals of FIG. 2, and another table of sampled-points;

FIG. 4 is an illustration of the display and the rendered signals of FIG. 2, wherein the signals are rendered in a magnified view, and a table with a scroll bar is displayed;

FIG. 5 is an illustration of the display showing a rendered signal and a portion of sampled-points in another embodiment of the invention;

FIG. 6 is a flow chart describing steps for identifying a display-point on a rendered signal on the measuring system;

FIG. 7 is a block diagram of major objects in an Object Oriented design implementation of an embodiment of the invention.

### DETAILED DESCRIPTION

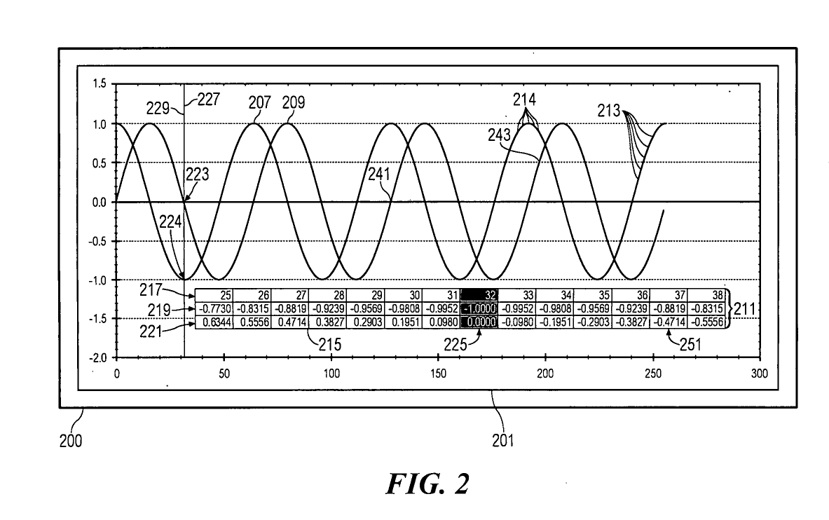

FIG. 2 is an illustration of a display 201 on a measuring system 200. The display 201 shows two rendered signals, a first rendered signal 209, and a second rendered signal 207. The rendered signals 207,209 have a multitude of display-points 213,214.

Sampled-points of both rendered signals 207,209 are displayed in a table 215. The table 215 contains 14 columns and three rows; an index row 217, and two magnitude rows 219,221. The rows 219 and 221 list the magnitudes of the first and second rendered signals 209,207 respectively. The 14 columns of the table 215 are presented in sequential order.

The content in the 14 columns is data derived from a portion 211 of the sampled-points of the signals.

Data in the index row 217 is an example of Meta Data of the sampled-points. Meta Data describes information about the magnitude rows 219,221. The index row 217 identifies the sequence order of the sampled-points stored in the MU 108. In other embodiments, the contents of the table 215 can be a sequence of sampled-points such that a difference in the sequence order of any two successive columns of the table 215 is two or more. Alternatively, the sampled-points 211 can be chosen in a geometric sequence from the sampled-points stored in the MU 108.

The contents of the table 215 are typically a subset of the sampled-points corresponding to the display-points 213,214 of the rendered signals 207,209 viewable in the display 201.

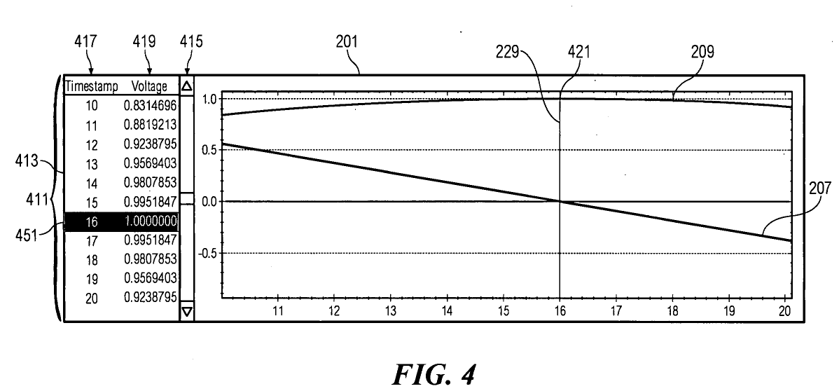

Alternatively, the contents of the table 215 can include all the sampled-points, or all the sampled-points that correspond to the display-points viewable in the display 201. In these embodiments, the table typically includes a scroll-bar (415 in FIG. 4) to aid with navigation.

An initial display-point 223,224 is identified on the rendered signals 207,209. A column 225 describing the magnitude of the initial display-point 223,224 of the rendered signals 207,109 is highlighted in the table 215.

Indicia 227 in the form of a vertical marker 229 is displayed at the initial display-point 223,224. Other examples of indicia 227 can be a cross-hair at a display-point, a brighter display-point, a higher contrasting display-point, a larger display-point, an icon image at a display-point, or a horizontal marker that cuts across the rendered signal at a display-point.

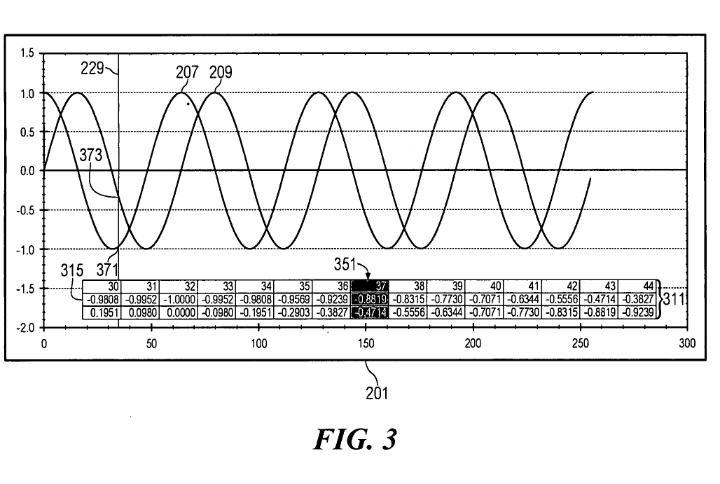

FIG. 3 is an illustration of the display 201 showing the rendered signals 207,209 and a different portion 311 of sampled-points in a table 315.

A selected column 351 of sampled-points is highlighted on the table 315. The selected column 351 is first visible in FIG. 2 as a column 251.

The rendered signals 207,209 are shown including the display-points 371,373 corresponding to the sampled-points in the selected column 351 (“selected display-points 371,373”).

The vertical marker 229 indicia is displayed at the selected display-points 371,373.

The size and structure of the table 315 is similar to that of the table 215 in FIG. 2. However, the contents of the table 315 differ from that of the table 215 as the portion 311 of sampled-points presented in the table 315 is centered on the selected column 351.

FIG. 4 is an illustration of the display 201 showing the rendered signals 207,209 in a magnified view.

A portion 411 of the sampled-points is displayed in a table 413. The table 413 has a scroll bar 415 on the side thereof for varying a viewable portion of the sampled-points. The scroll bar 415 is an example of a display movement mechanism.

The table 413 includes two columns of the coordinates of the sampled-points; a Meta Data column 417 provides timestamp information in a chronological order and coordinate column 419 displaying the magnitude of the first rendered signal 209.

A highlighted row 451 identifies sampled-points selected by the user. The vertical marker 229 indicia is displayed at a display-point 421 that corresponds to the sampled-points in the row 451.

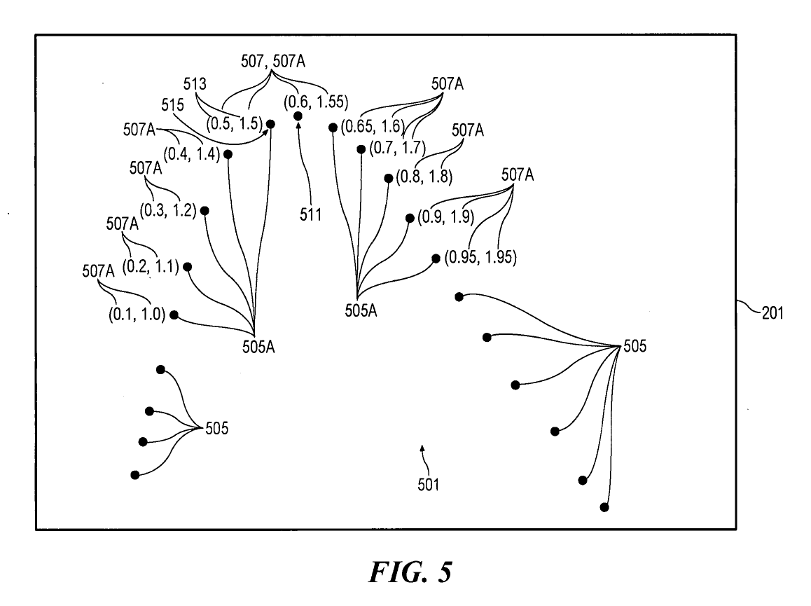

FIG. 5 is an illustration of the display 201 showing a rendered signal 501 and a portion 507 (not shown) of sampled-points in another embodiment of the invention. Display-points 505 make up a discrete representation of the rendered signal 501.

Data of the portion of the sampled-points is presented as coordinates 507A. The coordinates 507A are displayed adjacent to their corresponding display-points 505A. The corresponding display-points 505A are a subset of all the display-points 505 on the display 201.

The coordinates 507A show time and magnitude values of the portion of sampled-points of the rendered signal 501.

An initial display-point 511 is also identified on the display.

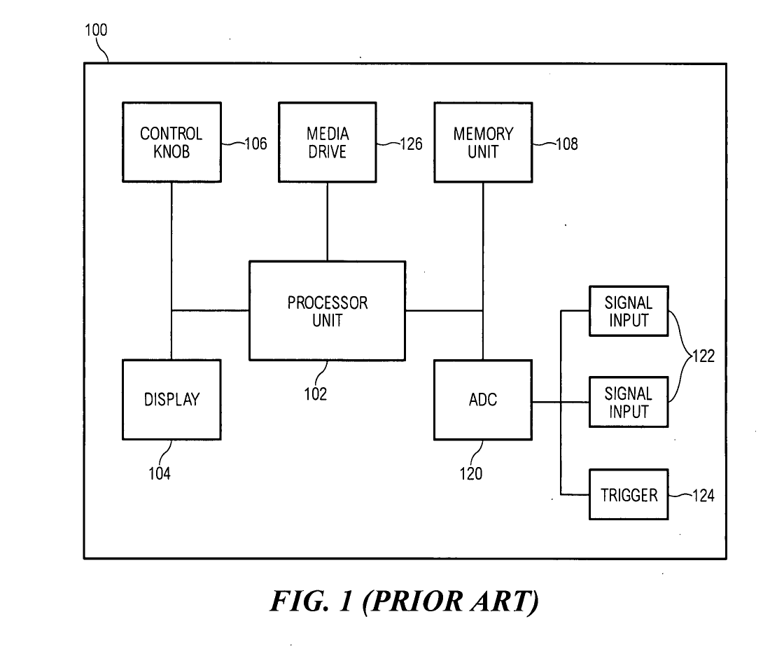

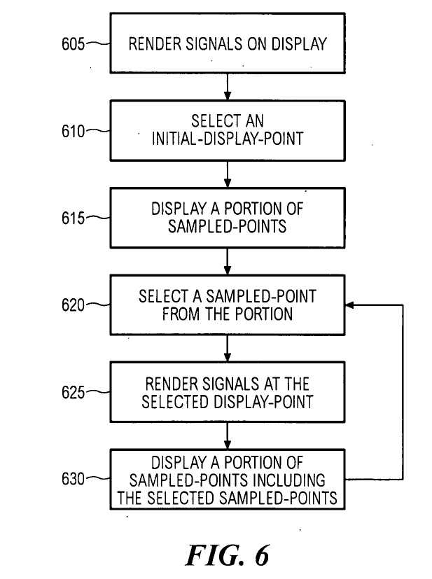

FIG. 6 is a flow chart detailing steps for identifying a display-point on a rendered signal on the measuring system 200. The STEPS in the flow chart are associated with the description of FIGS. 1-5.

At STEP 605, the processor unit 102 renders the signals on the display 201. For example, the rendered signals 207,209 and 501 are displayed on the measuring system 200.

At STEP 610, an initial display-point is selected. Indicia can be displayed at the initial display-point. The initial display-point can be selected by the user or can be a preselected display-point.

The preselected display-point is chosen by preference of a manufacturer of the measuring system 200. Alternatively, the preselected display-point can be identified by the user before an analysis commences. Examples of the preselected display-point can be a center display-point 241 of the first rendered signal 209, a threshold crossing 243 of the first rendered signal 209 or an algorithm. Indicia 227 can also be displayed at the preselected display-point.

For example, the initial display-points 223,224 or 511 can be user selected or preselected. The vertical marker 229 indicia can be displayed at the initial display-point 223,224 to identify the selection made.

At STEP 615, a portion of the sampled-points is displayed. The portion can include the initial display-point of STEP 610. The portion of sampled-points can be displayed exclusively or together with the rendered signals on the display 201. The content and the sequence of the portion of the sampled-points can also be changed if desired. This can be facilitated through the user interface.

The portion of sampled-points includes data pertaining to at least one rendered signal, Meta Data of the sampled-points or a timestamp of the data measured. The portion of sampled-points can be displayed in a table, a panel or as coordinates adjacent to the corresponding display-points.

For example, the portion 211 of sampled-points is displayed in the table 215. Additionally, the tabled can be centered on the column 225 representing the initial display-point 223. The rendered signals 207,209 can be displayed with the table 215.

Alternatively, the portion of sampled-points can be displayed in a single row, a single column, or another form as would be appreciated by those skilled in the art. In an embodiment wherein three-dimensional graphs are rendered, the table can display sampled-points of more than one measured parameter.

The table 215 can be a pop-up window, a floating window, or a window in a fixed position of the display 201.

The table can be resized by the user, allowing for part of the table's contents to change, if so desired. The scroll bar 415 can also aid the user in positioning the portion of sampled-points viewable.

The table can include descriptive statistics of the signal's sampled-points that are viewable therein. Examples of descriptive statistics can be the mean, media, standard deviation, minimum and maximum of the data from the portion of the sampled-points viewable on the display.

In another example, the coordinates 507A of the sampled-points are displayed. The coordinates 507A can also be displayed adjacent to the corresponding display-points 505A.

In the embodiment that the portion is displayed in conjunction with the rendered signals, the signals can also be rendered in a magnified view. In yet another variation to this embodiment, the user can select an area of the rendered signal on which to magnify, enabling the portion of sampled-points to represent part of the area selected.

At STEP 620, a sampled-point is selected from the portion of sampled-points in the display. This step can be facilitated through the user interface.

For example, the column 251 in the table 215 can be selected using the input interface. Similarly, the coordinates 513 can be selected using the input interface. (The coordinates 513 correspond to display-point 515.)

At STEP 625, the signals are rendered at the selected display-points.

For example, upon the selection of the column 251 in STEP 620, the signals are rendered to include the display-points 371,373 corresponding to the selected sampled-points in column 351. The vertical marker 229 can be displayed at the display-points 371,373.

Similarly, the rendered signal 501 is displayed to include the display-point 515.

In a variation to the embodiment, the signals can be rendered on a preselected point that can identify the selected display-points. In this STEP, the rendered signals 207,209 and 501 can be centered at the selected display-point 371,373 and 515 respectively.

In another variation of the embodiment, the signals can be rendered in a magnified view at the selected display-points. A magnification factor can be selected by the user or can be a value set by the manufacturer of the measuring system 200.

For example, the processor unit 102 can render the signals on the display 201 to include the display-point 421. The display-point 421 corresponds to the selected sampled-point in the row 451. The vertical marker 229 can be displayed at the display-point 421.

In yet another variation of the embodiment, the signals are rendered in a magnified view on a preselected point that will identify the selected display-point. For example, the rendered signals can be centered at the display-point 421 on the display 201.

At STEP 630, the different portion of the sampled-points, including the selected sampled-point, is displayed.

For example, the table 315 is displayed with a portion 311 of sampled-points different from that in STEP 615. The selected column 351 of sampled-points is also displayed in the table 315. The column 351 can be highlighted and positioned in the center of the table 315. In another example, the table 413 is displayed with the portion 411 of sampled-points. The selected row 451 is also visible in the table 413. The row 451 can be highlighted to help the user associate the selected sampled-point with the vertical marker 229 at the selected display-point 421.

The STEPS 620-630 can be repeated to find a particular point of interest in the rendered signals.

The steps of FIG. 6 related to implementing the embodiments of the invention can be executed as computer code. The code resides on computer readable media. The code is used by the processor unit 102 to execute the instructions. The computer readable media can be, for example, a ROM, a RAM, a DVD, a hard drive, or other computer readable media known in the art.

Alternatively, the code can be executed by a computer external to the measurement system 200, which controls the measurement system 200.

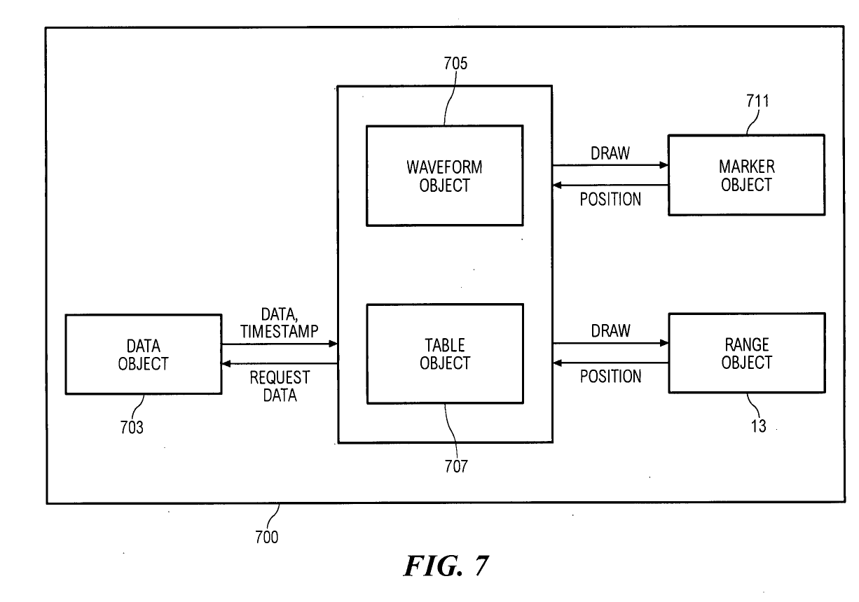

FIG. 7 is a block diagram representation of major objects for the implementation of an Object Oriented design 701 in an embodiment of the invention. The Object Oriented design 701 can be implemented in C++ language. The code can be stored on computer readable media 700, which can be read by the computer readable media drive 126. Alternatively, the code can be stored on the MU 108.

A Data Object 703 provides the sampled-points. The Data Object 703 calculates the number of display-points to render the signals 207,209 or 501 using data position and a scale factor. It can return the display-points to the requesting object by the start time and end time of display-points.

A Waveform Object 705 renders the display-points in a graphical representation of the signal.

A Table Object 707 displays the portion 211,311,411 or 507A of the sampled-points on the display 201. Both, the Waveform Object 705 and Table Object 707, are sampled-points-rendering-Objects that can be inherited from a more abstract object, for example, a vector class or a record object.

A Marker Object 711 is tied or displayed on the Waveform Object 705 and the Table Object 707. There may be more than one marker object for each Waveform Object or Table Object.

A Range Object 713 is another optional object drawn in the Waveform Object 705 and Table object 707, where a start point and an end point are selected.

Although the invention is described herein with reference to the preferred embodiment, one skilled in the art will readily appreciate that other applications and equivalents may be substituted for those set forth herein without departing from the spirit and scope of the present invention. For example, a variety of devices that use a display screen and display-points can employ the invention to identify a point on the display.

It should be understood that the invention is only defined by the following claims.

1. A method for identifying a display-point on a rendered signal, the rendered signal comprising display-points, the display-points corresponding to sampled-points of a signal, the method comprising:
displaying a portion of the sampled-points;
selecting a sampled-point from the portion of the sampled-points; and
rendering the signal, wherein the rendered signal includes the display-point corresponding to the selected sampled-point.

2. The method of claim 1, wherein the step of displaying the portion of the sampled-points comprises the step of displaying the portion of the sampled-points in a table.

3. The method of claim 1, prior to the step of displaying the portion of the sampled-points, the method further comprises the steps of:
rendering the signal;
selecting one display-point as an initial display-point; and
wherein the portion of the sampled-points in the step of displaying the portion of the sampled-points includes a sampled-point corresponding to the initial display-point.

4. The method of claim 1, wherein the step of rendering the signal to include the display-point comprises the step of displaying indicia at the display-point.

5. The method of claim 1, wherein the step of rendering the signal to include the display-point comprises the step of centering the rendered signal at the display-point.

6. The method of claim 1, after the step of rendering the signal to include the display-point, the method further comprises the step of displaying a different portion of sampled-points, wherein the different portion of the sampled-points includes the selected sampled-point.

7. The method of claim 1, wherein the step of rendering the signal comprises the step of rendering the signal in a magnified view.

8. The method of claim 1, wherein the step of displaying the portion of the sampled-points includes displaying Meta Data of the sampled-points.

9. The method of claim 1, wherein the portion of sampled-points is the same as the sampled-points.

10. A measurement system comprising:
a computer readable media for storing sampled-points of a signal;
a display adapted to display a portion of the sampled-points;
an input device communicating with the display to select a sampled-point from the portion of the sampled-points; and
a processor unit coupled to the computer readable media, the input device and the display, the processor unit for rendering the signal on the display, wherein the rendered signal includes a display-point corresponding to the selected sampled-point, and the rendered signal comprising display-points corresponding to a part of the sampled-points.

11. The system of claim 10, further comprising indicia, the indicia being displayed at the display-point.

12. The system of claim 10, further comprising:
an initial display-point, wherein the display is adapted for rendering the signal comprising the initial display-point, and wherein the portion of the sampled-points comprises a sampled-point corresponding to the initial display-point; and
indicia, wherein the initial display-point is identified by the indicia on the display.

13. The system of claim 12, wherein the initial display-point is identified by a preselected point on the display.

14. The system of claim 10, wherein the measurement system is an oscilloscope, a spectral analyzer, or a computer based measurement device.

15. The system of claim 10, wherein the input device is a mechanical device on the measurement system or a soft key on the measurement system.

16. The system of claim 10, wherein the portion of the sampled-points is displayed in a table and comprises a display movement mechanism for varying a viewable portion of the sampled-points.

17. A computer readable media containing code thereon, the code providing instructions to a system for executing the steps of:
displaying a portion of the sampled-points;
receiving a command input to select a sampled-point from the portion of the sampled-points; and
rendering a signal at a display-point corresponding to the selected sampled-point.

18. The computer readable media containing code thereon as recited in claim 17, prior to the step of displaying a portion of the sampled-points, the code providing instructions to the system for executing the additional step of receiving the sampled-points of the signal.

19. The computer readable media containing code thereon as recited in claim 17, wherein the step of rendering the signal at the display-point comprises the step of displaying indicia at the display-point.

20. The computer readable media containing code thereon as recited in claim 17, the code providing instructions to the system for executing the additional step of rendering the signal in a magnified view.
